(19) United States
(12) Patent Application Publication
(10) Pub. No.: US 2008/0026483 A1
(43) Pub. Date: Jan. 31, 2008

(54) THERMAL-CYCLING DEVICES AND METHODS OF USING THE SAME

(76) Inventor: Kevin R. Oldenburg, Spokane Valley, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/763,384

(22) Filed: Jun. 14, 2007

Related U.S. Application Data
(60) Provisional application No. 60/813,656, filed on Jun. 14, 2006.

(51) Int. Cl. G01N 1/00; B01J 19/00; B01L 3/00

(52) U.S. Cl. 436/174; 422/102; 422/307

(57) ABSTRACT

A thermal-cycling device for thermally processing at least one substance carried by a thermally-conductive microwell plate includes a heating-cooling unit that may be placed in thermal contact with a surface of the microwell plate. The microwell plate may include at least one well that may have low volume capacity. In one embodiment, the microwell plate is transported by a carrier in the thermal-cycling device and positioned in thermal communication with the heating-cooling unit. The heating-cooling unit may include one or more Peltier units, a heat sink and a heat spreader.

### CROSS-REFERENCE TO RELATED APPLICATION

This application claims the benefit of the filing date of U.S. Provisional application 60/813,656, filed on Jun. 14, 2006, the entire contents of which is incorporated herein by reference.

### BACKGROUND OF THE INVENTION

1. Field of the Invention

The field of this invention generally relates to a thermal-cycling device for processing substances such as biological and/or chemical reaction samples and methods of using the same.

2. Description of the Related Art

Thermal-cycling devices are typically used for a variety of heating and cooling processes. One such process is the thermal cycling of biological and/or chemical substances to achieve desired reactions thereof. For example, a thermal-cycling device may be used to produce a polymerase chain reaction (PCR) of a biological substance. One type of PCR process is described in U.S. Pat. No. 4,683,202.

Conventional thermal-cycling devices include a formed thermal block in which tubes or plates carrying the substance to be reacted are placed above or even embedded in the thermal block for heating and/or cooling thereof.

Conventional thermal-cycling devices typically take several hours to complete a PCR run because of the amount of time needed to bring the thermal block to a stable, uniform temperature. In addition, at least some volume of the substance to be reacted is often lost through evaporation and/or condensation as the substance is processed through high and low temperature cycles when a conventional thermal-cycling device is used.

The technology currently in widespread use comprises a microtiter (microwell) plate supported on top of a thermal block, where Peltier units are attached to an underside of the thermal block. The microwell plate is usually constructed from thin-walled polypropylene having small wells typically arranged in a grid of either 96 or 384 wells, which is inserted into or supported on top of the thermal block. The thermal block is typically constructed from aluminum. The Peltier units are used to heat or cool the thermal block, which then heats or cools the substance(s) within the microwell plate wells somewhat like a pot on a stove. The temperature of the substance(s) within the microwell plate wells are controlled by heating or cooling the thermal block.

The long duration of time needed to bring the thermal block to a stable, uniform temperature is due to the thermal block having a relatively large thermal mass. Much of the energy used during a thermal-cycling process is used to heat or cool the thermal block rather than the microtiter plate and the substance(s) in the wells of the microwell plate.

Conventional thermal blocks may have a thermal mass that is at least one hundred times larger than the thermal mass of the collective substances within the wells of the microwell plate. In addition, the microwell plates are typically polypropylene plastic, which is considered a relatively good thermal insulator. This conventional arrangement results in heating and cooling cycles that may take at least a number of hours to complete. The Peltier units attached to the underneath side of the thermal block can heat quickly, but their cooling capacity is limited by the rate at which they can dissipate heat, which is usually through some type of heat sink or heat exchanger. Thus, the larger the thermal mass of the thermal block that has to be heated or cooled and the greater the change in temperature desired for a given cycle, the longer it takes the Peltier units to accomplish the task.

In addition to the large thermal mass of the conventional aluminum thermal blocks, these thermal blocks are difficult to machine and are limited to holding microwell plates of up to only certain well capacities. For example, conventional thermal blocks can be machined to receive up to a 384-well microwell plate. Constructing a thermal block with a well capacity of 1536 wells, for example, would be difficult and costly, and the walls between wells would be quite thin and susceptible to damage when the microwell plates are inserted into the thermal block.

As mentioned, the microwell plates are typically constructed from plastic, usually polystyrene or polypropylene. In most cases, polypropylene is used because it can be used to mold plates with thinner walls than polystyrene. Both plastics are good thermal insulators. Polypropylene, for instance, has a thermal conductivity of approximately 0.15 Watts/meter*Kelvin compared to copper, which has a thermal conductivity of approximately 400 Watts/meter*Kelvin. Consequently, to transfer heat into or away from the substance(s) in the wells of the plastic microwell plate, the heat must transfer through a microwell plate (i.e., a good thermal insulator), which additionally slows down the heat transfer process. In addition, the conventional plastic microwell plates often change shape upon heating and/or cooling, especially when subjected to the high temperatures of a PCR thermal-cycling process. The shape change may cause the conventional microwell plates to become lodged in the thermal block and make it difficult, if not impossible, for a robotic arm, for example, to remove the microwell plate from the thermal block.

In addition, conventional microwell plates that are placed onto thermal blocks typically have a volumetric capacity on the order of 30-40 microliters. When low volumes of substances, for example 1-5 microliters, are processed in the conventional plates, there is a significant amount of air space above the substance. As the thermal-cycling process progresses, the water vapor in the air may evaporate and/or condense (at 95° C. and 100% humidity, 30 microliters of air will hold approximately 0.015 microliters of water). Further, the wells of the conventional plastic microwell plates, in particular the upper portions of the wells that are in contact with only air, may often have a temperature that is at least slightly lower than the temperature of the substance at the bottom portion of the well. This temperature differential causes the water vapor in the air to condense out of the air and precipitate onto the walls of the wells. This type of condensation and/or evaporation may be somewhat minimized by providing a heated lid over the conventional microwell plate, but caution must be taken such that the heating element in the lid does not adversely effect and/or damage the conventional plastic microwell plate.

Another drawback of conventional thermal-cycling devices is the evaporation of water located with and/or from the substance(s) in the wells of the microwell plate. When samples (i.e., substances) are heated from the bottom, water evaporates from the samples and condenses on either the walls of the respective wells or on a lid placed on top of the microwell plate. By way of example, a typical 384-well microwell plate used in a PCR process may have a total well volume of approximately 40 microliters, yet up to 3 microliters of water may evaporate from the total volume and condense on the walls of the wells or the lid during one temperature cycle. To alleviate this problem, the sample volume is increased to be at least 5-6 microliters, so that the concentration of the sample does not change appreciably when evaporation occurs. Additionally or alternatively, some conventional thermal-cycling devices use a heated lid placed proximate to a top surface of the microwell plate to keep the water vapor in the wells from evaporating, or at least from evaporating in large amounts onto the lid.

Although the heated lid helps with reducing the amount of evaporation in the wells, the heated lid makes it more difficult to automate the thermal-cycling process because the microwell plate, with the heated lid coupled to the thermal-cycling device, cannot be easily manipulated. In lieu of the heated lid, it has been known to use oils, waxes, and/or other materials as an overlay on the sample in the well to limit evaporation. However, the oils, waxes, and/or other materials may cause problems in downstream sample processing such as contamination of the sample.

In addition to the conventional thermal-cycling devices discussed above, other thermal-cycling devices have been introduced that use capillary or microfluidic channels to pass the samples through the thermal block. However, inserting the samples into and removing them from the channels may be problematic, for example, greater sample volumes may be needed and cleaning of the channels may be difficult and/or time-consuming. Further, the channels must be sealed to maintain the sample within the channel, but any micro-leak and/or slightly broken seal may contaminate the sample.

To reiterate, one of the major drawbacks of conventional thermal-cycling devices is the amount of time it takes to completely process the substance(s). By way of example, a conventional thermal-cycling device operated to run about thirty temperature cycles during a PCR process may take in excess of two hours to complete those thirty cycles. Accordingly, labs, research facilities, etc. often need to purchase and maintain many thermal-cycling devices in order to keep up with both the upstream and downstream processes. This equates to larger capital expenditures, labor costs, and facilities costs. Alternatively, the number of thermal-cycling devices on hand may severely limit the productivity of labs, research facilities, etc. that have limited budgets.

FIGS. 1 and 2 show a conventional thermal-cycling device 10 comprising a housing 12, a lid 14, and a heating-cooling unit 16. The lid 14 may include a secondary heating element 18 to help control any evaporation of the substance being processed, as discussed above. A thermal block 20 is placed on top of the heating-cooling unit 16 to heat or cool the substance, where the substance is typically placed in a tube, which is then placed in at least one of the wells 22 in the thermal block 20. As illustrated in FIG. 2, the heating-cooling unit 16 includes a Peltier unit 24 in electrical contact with conductor plates 26, where the lower conductor plate 26 is coupled to a heat sink 28. In addition, a cooling fan 30 may be located near the heating-cooling unit 16 to enhance the cooling process.

In conventional microwell plates, the wells typically have a volumetric capacity on the order of 30-40 microliters. As mentioned, when low volumes of substances are processed in the conventional plates, there may be a significant amount of air space above the substance as well as a significant amount of plastic above the substance. If the temperature of this plastic is at or slightly lower than the temperature of the sample, water will condense out of the air and precipitate on the plastic. Consequently, a reaction may lose up to 3 microliters of water which condenses on the walls of the plate. These evaporation effects are somewhat minimized by the use of a heated lid on the thermal cycler but they cannot be completely overcome because of the use of a standard plastic microwell sample plate.

Accordingly, there is a need for a thermal-cycling device having reduced processing times and/or adapted to receive a thermally-stable microwell plate having a large number of wells and/or having small well volume capacities.

### BRIEF SUMMARY OF THE INVENTION

This description generally relates to a thermal-cycling device having a heating-cooling unit positioned to heat or cool a thermally conductive microwell plate. The microwell plate comprises a plurality of wells that carry a desired volume of at least one type of substance. The microwell plate can be moveable to be positioned in thermal communication with the heating-cooling unit. In one embodiment, the heating-cooling unit may include at least one or more Peltier units.

In one aspect, a thermal-cycling device for thermally processing at least one substance includes a housing; a heating-cooling unit moveably coupled to the housing; a carrier operable to translate with respect to the housing; and a plate having a plurality of wells and a surface, the wells being configured to retain desired volumes of the at least one substance, at least a portion of the surface being moveable relative to the heating-cooling unit to be in thermal communication therewith.

In another aspect, a method for thermally processing at least one substance in a thermal-cycling device includes supporting a thermally conductive microwell plate on a carrier, the plate carrying the at least one substance in a well formed in the plate; moving the carrier and the plate from a first position to a second position, wherein the second position the plate is located adjacent a heating-cooling unit and in thermal communication therewith; and changing a temperature of the plate by a desired amount by changing a temperature of the heating-cooling unit.

In yet another aspect, an apparatus includes a thermally-conductive material configured to be received by a thermal-cycling device; and at least one depression formed in the thermally-conductive material, the depression configured to hold a desired volume of a substance; wherein a thermal conductivity of the thermally-conductive material permits a temperature change of the material to rapidly affect a temperature of the substance.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale and some of these elements are arbitrarily enlarged and positioned to improve drawing legibility. Further, the particular shapes of the elements as drawn are not intended to convey any information regarding the actual shape of the particular elements and have been solely selected for ease of recognition in the drawings.

FIG. 1 is an isometric view of a conventional thermal-cycling device according to prior art.

FIG. 2 is an isometric view of a portion of the conventional thermal-cycling device of FIG. 1.

FIG. 3 is an isometric view of a thermal-cycling device according to one embodiment of the present invention.

FIG. 4 is an isometric view of a thermal-cycling device according to another embodiment of the present invention.

FIG. 5 is an exploded view of a portion of the thermal-cycling device of FIG. 4.

FIG. 6 is a plan view of a thermally conductive portion of a microwell plate of a thermal-cycling device according to yet another embodiment of the present invention.

FIG. 7 is a cross-sectional view of the thermally conductive portion of a microwell plate of FIG. 6, viewed along section 7-7.

FIG. 8 is a detail view of a well of the thermally conductive portion of a microwell plate of FIG. 7.

FIG. 9 is an isometric view of a portion of the thermal-cycling device of FIG. 4 comprising a thermally conductive portion of a microwell plate 120 and a carrier 106.

FIG. 10 is a flow diagram of a thermal-cycling method according to one embodiment of the present invention.

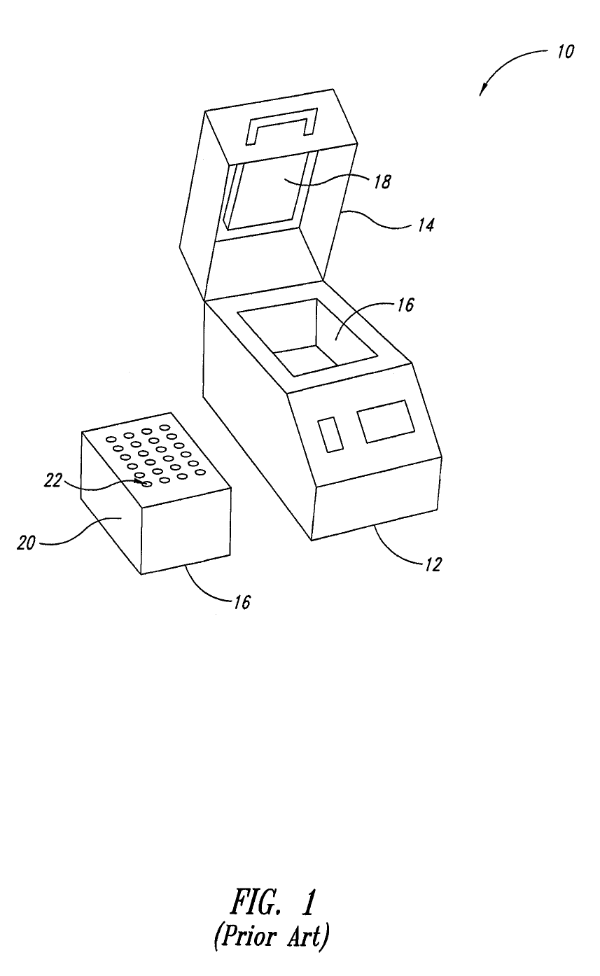

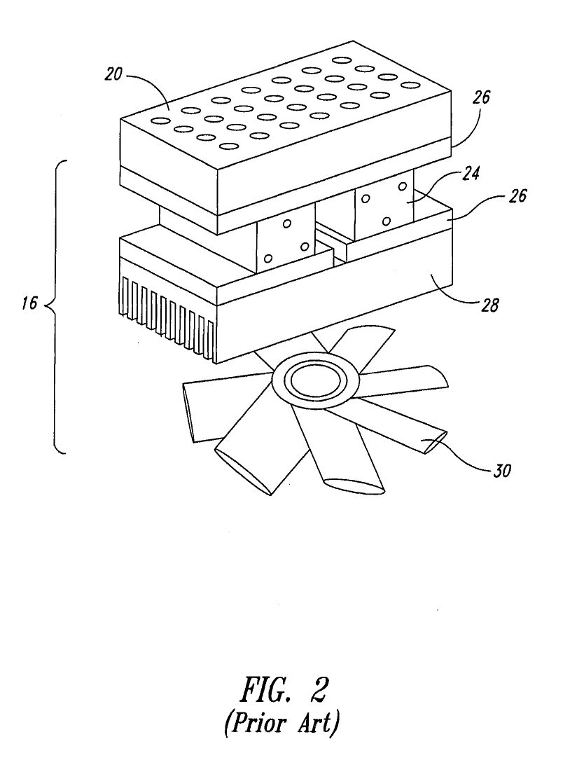

### DETAILED DESCRIPTION OF THE INVENTION

In the following description, certain specific details are set forth in order to provide a thorough understanding of various embodiments of the invention. However, one skilled in the art will understand that the invention may be practiced without these details. In other instances, well-known structures and methods associated with thermal-cycling devices, microwell and/or microtiter plates, and Peltier and/or thermoelectric devices may not be shown or described in detail to avoid unnecessarily obscuring descriptions of the embodiments of the invention.

Unless the context requires otherwise, throughout the specification and claims which follow the word “comprise” and variations thereof, such as “comprises” and “comprising,” are to be construed in an open, inclusive sense, that is, as “including, but not limited to.”

The headings provided herein are for convenience only and do not interpret the scope or meaning of the claimed invention.

The following description generally relates a thermal-cycling device that may be used in combination with a unique microwell plate supported by a carrier. The thermal-cycling device may be used to initiate reactions of chemical or biological substances. The thermal-cycling device generally includes a heating-cooling unit to heat and/or cool samples of substances carried in the microwell plate. During a thermal cycling operation, the heating-cooling unit is located proximate the microwell plate and is placed either in direct contact with a surface of the plate or in contact with a thin film placed over the top surface of the plate. The thermal-cycling device may be programmable and/or may be used in conjunction with other automated and/or robotic equipment. In addition, in at least one embodiment, the thermal cycling device does not include a standard thermal block 20, as in conventional thermal cyclers.

Thermal-Cycling Device

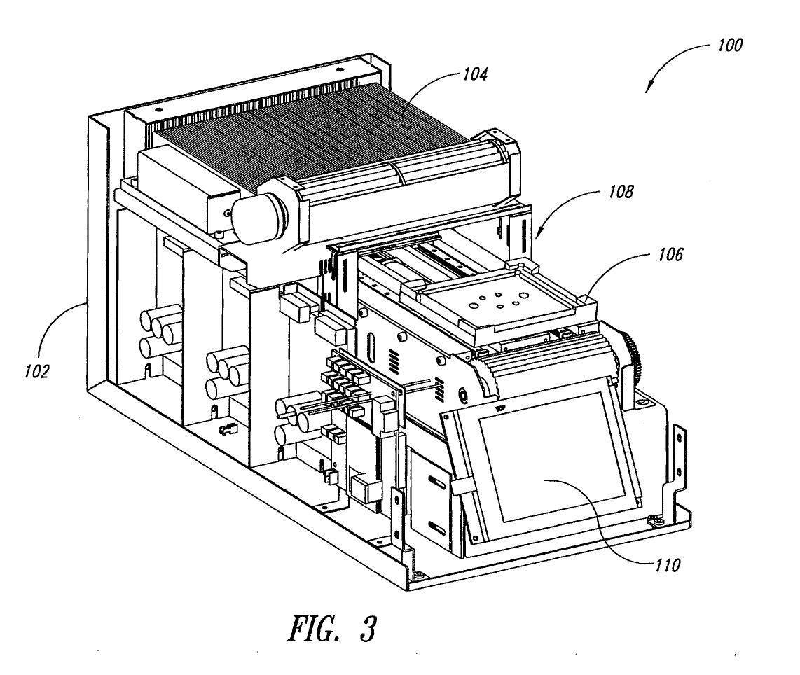

FIG. 3 illustrates a thermal-cycling device 100 comprising a housing or frame 102, a heating-cooling unit 104, and a metal slide 105 that may be used to hold the microwell plate 120 or 203, according to one embodiment. The metal slide 105 is moveable on a transport system 108, such as a conveyor, to move between a first position distal from the heating-cooling unit 104 and a second position proximate, for example beneath, the heating-cooling unit 104. Optionally, the thermal-cycling device 100 may include an input/output (I/O) display screen 110 for programming and/or monitoring the thermal-cycling device 100. In one embodiment, the I/O display screen 110 is a liquid-crystal display screen with touch screen features for at least entering data and/or operational parameters. In this or other embodiments, the thermocycler may be controlled remotely by the user via computer or computer system. Such computer or computer system may be programmable, and may be capable of receiving, storing and/or reporting data set points input by the user to define at least one time and temperature profile, as well as means for carrying out the profile(s) upon further input by the user. The computer or computer system may also be capable of cycling the time and temperature profile(s) multiple times in a user-controlled or user-selected sequence or manner.

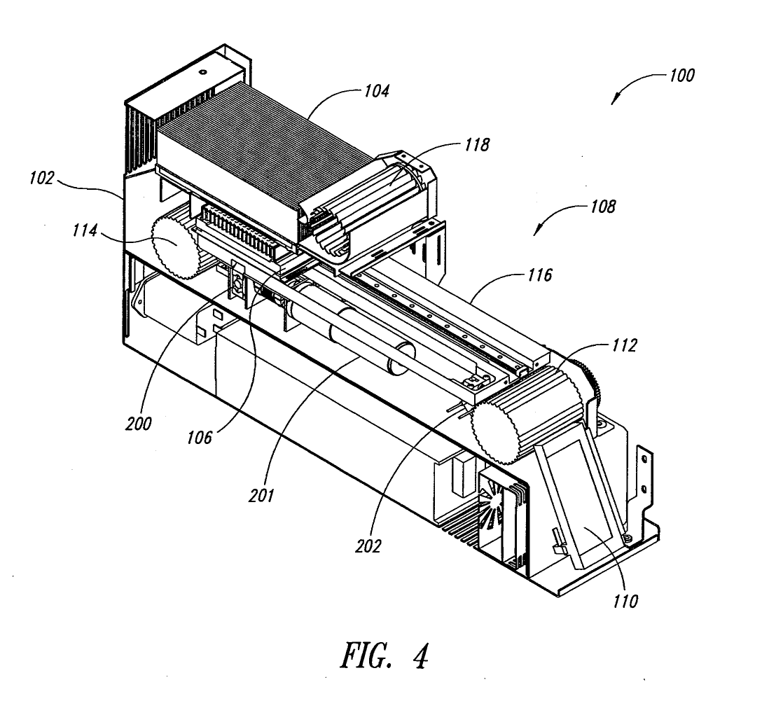

FIG. 4 illustrates a cut away view of one embodiment showing further detail. The transport system 108 includes a first roller 112 and a second roller 114 in cooperation with one another to move the metal slide 105 along a track 116.

In another embodiment, a cam mechanism 200 driven by a cam motor 201 and/or a belt drive motor 202 can be operable to move the microwell plate 120 or 203 (FIG. 5), which may include the sealing film 126, into and out of contact with a non-moving or stationary heating-cooling unit 104. In other embodiments, the heating-cooling unit 104 can be located below the microwell plate 120 or 203, in direct or indirect contact with a surface, such as a bottom surface, of the microwell plate 120 or 203. Those of skill in the art having reviewed this disclosure will appreciate this and other modifications that can be made to the positioning of the heating-cooling unit 104 with respect to the microwell plate 120 or 203. For example, the heating-cooling unit 104 may be located on any side of the microwell plate 120 or 203, including the top, bottom, either or both side(s), any combination thereof or any other position that may promote thermal communication of the heating-cooling unit 104 with the microwell plate 120 or 203.

FIG. 5 illustrates the heating-cooling unit 104, the carrier 106, the thermoconductive portion of the microwell plate 120, and the sealing film 126. The heating-cooling unit 104 comprises a plurality of thermoelectric modules 124, often referred to as Peltier modules, corresponding heat sinks 122, and optionally, at least one heat spreader 125. The general configuration of the thermoelectric or Peltier modules 124 is known in the art as a semiconductor-based electronic component that functions as a small heat pump. Typical thermoelectric modules 124 may be used for heating and cooling by reversing the polarity of the applied current through the p-type and n-type semiconductor material (such as bismuth telluride). The heat sinks 122 are configured to minimize thermal resistance and may be made from a conductive material having an exposed surface area.

Additionally or alternatively, the heat sinks 122 may include forced air and/or liquid circulation cooling and/or heating systems. In one embodiment, heat is removed from the heat sink by rapidly moving air across the fins of the heat sink via the fan 118. The three basic types of heat sinks 122 generally used with Peltier modules 124 are natural convective, forced convective, or liquid cooled. Those skilled in the art will appreciate and understand the configuration of the Peltier module 124 and its corresponding heat sink 122. Further, an optional heat spreader 125 facilitates an even distribution of temperature, such as heat, transferred from the heating-cooling unit 104 to the microwell plate 120 or 203 and/or the sealing film 126, in embodiments where the film 126 is provided, resulting in a more evenly distributed thermal flow across the microwell plate 120 or 203. Such a heat spreader 125 may comprise any thermoconductive material, including metals, ceramics, or other materials. In one particular embodiment, the heat spreader 125 comprises aluminum nitride.

The present invention further comprises one or more thermosensors in electronic or physical communication with one or more thermoregulators which may be positioned at any number of possible locations on the thermocycling device and/or microwell plate 120 or 203. In certain aspects, the thermosensors are in thermal communication with the microwell plate 120 or 203 and electronic communication with the programmable computer, if provided. Such thermosensors and/or thermoregulators are capable of sensing, relaying, reporting and/or regulating the temperature of at least the thermoconductive portion of the microwell plate 120, in conjunction with the programmable computer, if provided. The thermosensors and/or thermoregulators provide feedback according to the established or desired time and temperature profile parameters of the thermocycling device, thereby regulating the temperature of the plate 120 or 203. In one embodiment, one or more thermosensors are embedded in the heat spreader 125. In another embodiment, one or more thermosensors are embedded in the microwell plate 120 or 203. In still another embodiment, one or more thermosensors are embedded among or on a surface corresponding to the unit comprising the Peltier modules 124.

Multiple Peltier modules 124 may be positioned in parallel, in series or separately for establishing multiple thermal zones or areas of varying temperature in the thermal cycler device 100. One of skill in the art would understand that one or more Peltier modules 124 may be used in establishing one or more thermal zones. A thermal zone may be designated by a single Peltier unit 124 or a plurality of Peltier units 124 acting in concert. In at least one embodiment, a single thermal zone exists in the thermal cycler 100, and in other embodiments, two, three, four, five, six, seven, eight, nine, ten or more thermal zones may exist.

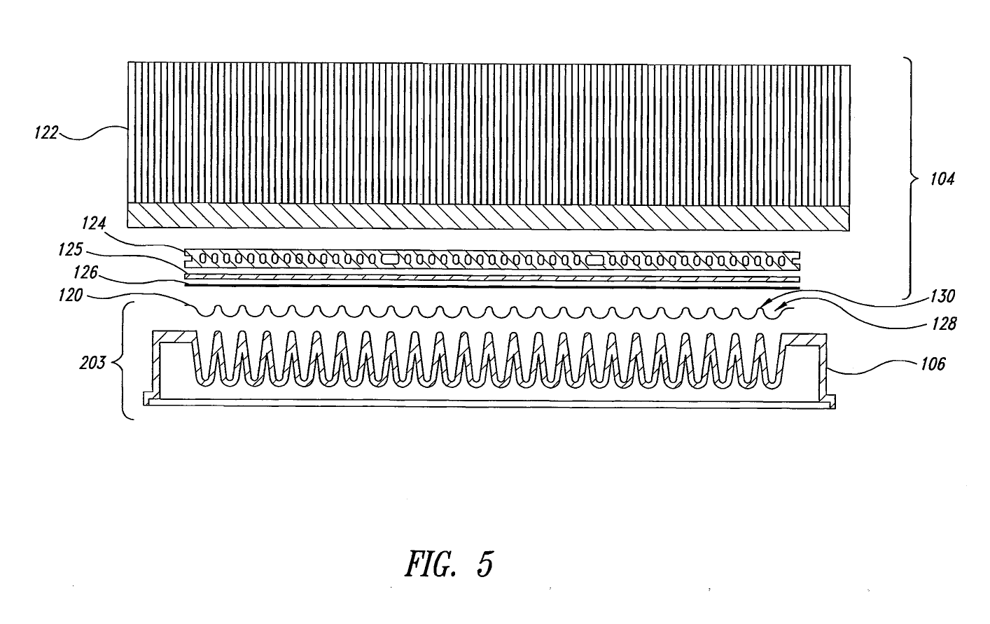

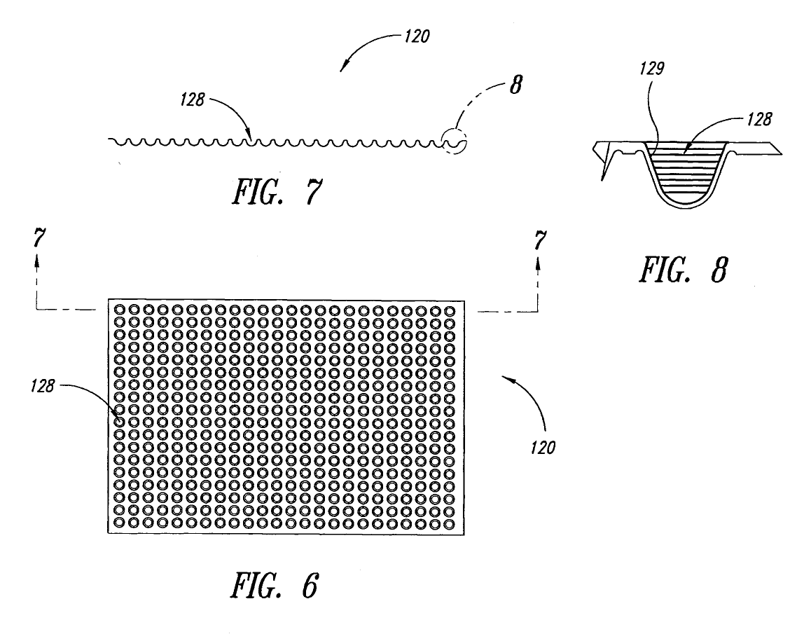

Microwell Plate In certain aspects of the invention, the microwell plate 203 may comprise three parts: the plate carrier 106, a thermally conductive portion 120, and a non-reactive coating 129 applied to the thermally conductive portion. In other aspects, the carrier 106 and/or non-reactive coating 129 are optional. FIGS. 6, 7, and 8 show the thermally conductive portion 120 of the microwell plate 203 having a plurality of wells 128 configured to retain at least one substance, such as a chemical or biological reaction sample. In one embodiment, the wells 128 are configured to retain biological material that was prepared for a PCR thermal-cycling process. The microwell plate 120 or 203 may include two or more, for example many more, wells 128. Depending on the application, microwell plates can be manufactured with, for example, 96, 384, 1536, 3456, or 9600 or more wells.

The wells 128 may comprise any shape, for example a conical or frustoconical shape (e.g., dimples or cavities) where the size, diameter, and/or depth, of the wells 128 may be customized based upon a particular application, purpose, manufacturing technique, and/or chemical or biological process. By way of example, at least some of the wells 128 of a 96-well microwell plate may have a diameter in a range of about 1.0 mm to 8.5 mm and a depth in a range of about 0.1 mm to 14.0 mm. Similarly, at least some of the wells 128 of a 1536-well microwell plate may have a diameter in a range of about 0.1 mm to 2.0 mm and a depth in a range of about 0.1 mm to 11.0 mm. It is understood and appreciated that other well configurations, sizes, shapes, etc. may be possible. It is further appreciated that the plurality of wells 128 need not have the same shape and/or size on a given thermally conductive portion of the microwell plate 120. Accordingly, a single thermally conductive portion of the microwell plate 120 may be manufactured with individual or groups of wells 128, each well 128 or each group of wells 128 having varying configurations.

In certain embodiments, the well volume may be less than or equal to approximately 500 microliters, 100 microliters, 50 microliters, 10 microliters, 5 microliters, 4 microliters, 3 microliters, 2 microliters, 1 microliter, 800 picoliters, 500 picoliters, 200 picoliters, 100 picoliters, 50 picoliters, 25 picoliters, 10 picoliters, 5 picoliters, or any value therebetween.

According to one embodiment, the thermally conductive portion of the microwell plate 120 can be made from a thermally-conductive metal, such as copper, aluminum, or any combination thereof or any material or combination of materials having a heat flux of at least 5.0 calories/meter*° Celsius*second. In one embodiment, the thermally conductive portion of the microwell plate 120 is a thin, continuous copper sheet. Additionally, or alternatively, the thermally conductive portion of the microwell plate 120 may comprise a plurality of sections made of different thermally-conductive materials. The thermal mass of the dimpled copper sheet is similar to that of the plurality of samples being thermally cycled.

Further, the thermally conductive portion of the microwell plate 120 can be sterile and/or may be sterilized before each use. In another embodiment, the thermally conductive portion of the microwell plate 120 is RNAse, DNAse, and/or protease free. The thermally conductive portion of the microwell plate 120 may be constructed from any thermally-conductive material having a thermal conductivity of at least 5 calories/meter*° Celsius*second, where the thermally conductive portion of the plate 120 is conformable into a desired shape. Optionally, the material of the thermally conductive portion of the plate 120 does not interfere with the biological and/or chemical reaction to be performed. In one embodiment, the thermally conductive portion of the microwell plate 120 is formed from a copper sheet that is stamped with a tool and dye to form the plurality of wells 128 having desired shapes and/or well volume capacities.

The microwell plate 203 may comprise the thermally conductive portion 120 bonded to the plastic plate carrier 106 by any physical, chemical, or physico-chemical means. Any number of adhesives may be suitable for bonding the two parts of the microwell plate 203, including 3M super 77 spray adhesive or a similar adhesive.

The thermally conductive portion of the microwell plate 120 made from a thermally-conductive material, for example, a type of metal, is much less likely to warp or distort when subjected to the temperature cycles and since it is in contact with only a very limited surface on the carrier 106, it does not transmit enough heat to the carrier 106 to heat the carrier to the same extent as would be the case in a conventional thermocycler. In contrast, conventional microwell plates have been known to warp or distort during the thermal-cycling process. Warping of the microwell plates during thermal cycling may cause the plates to bind in the thermal block and thus create difficulties when the plate is manually or robotically removed from the thermal-cycling device. However, the microwell plate 203, does not deform significantly during thermal cycling, because the carrier 106 is not subjected to large thermal changes and does not have significant surface area in direct contact with the heating/cooling unit, which in turn reduces or eliminates the possibility of the plate 203 becoming lodged or stuck in the thermal-cycling device 100.

The thermally conductive portion of the microwell plate 120 having a high thermal conductivity allows at least the desired portions of the thermally conductive portion of the microwell plate 120 to be at a same temperature, nearly at the same temperature, and/or be changing temperature at nearly a same rate as the substances that are located in the wells 128 of the thermally conductive portion of the microwell plate 120. This uniform and consistent heating/cooling arrangement can substantially minimize formation of condensation on the walls of the wells 128 of the thermally conductive portion of the microwell plate 120 and/or on the sealing film 126. Further, evaporation of the substances in the wells 128 may also be substantially minimized or eliminated.

The wells 128 may be formed in the thermally conductive portion of the microwell plate 120 to have low volume capacities. Low volume capacities help minimize the amount of air between the substance(s) in the wells 128 and the sealing film 126, for example when the sealing film 126 is placed on top of the thermally conductive portion of the microwell plate 120. Hence, the relatively shallow wells 128 and placing the heating-cooling unit 104 in thermal contact with the thermally conductive portion of the microwell plate 120 may accomplish a rapid temperature equilibration between the thermally conductive portion of the microwell plate 120 and the substance(s) in the wells 128 of the thermally conductive portion of the microwell plate 120. Likewise, very little, if any, condensation is able to accumulate on the sealing film 126 or on the upper portions of the wells.

Coatings for the Microwell Plate

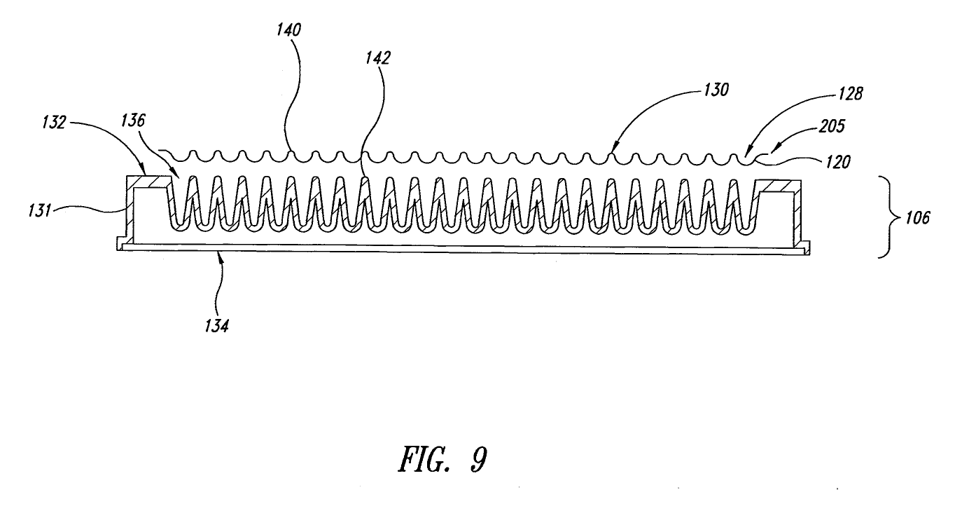

As illustrated in FIG. 8 at least part of the thermally conductive portion of the microwell plate 120 can be coated with a non-reactive coating 129, such as Teflon® (polytetrafluoroethylene), silicone, or another coating such as a type of plastic (e.g., a thermosetting or thermoplastic compound). Some examples of plastics that may be utilized include, but are not limited to, acrylic-styrene-acrylonitrile, ethylene-vinyl acetate, polybutylene terephthalate, polystyrene, acrylics, polyacrylics, polyolefins, polyurethanes, epoxy resins, melamine and urea formaldehyde, polycarbonate, polymethane, acrylonitrile-butadiene-styrene, phenolic, polyethylene, polyvinyl chloride, chlorinated polyvinyl chloride, polybutylene, polyphenylene oxide, thermoset polyester, polyethylene terephthalate, polypropylene, bioplastics (such as corn, wheat, milk, or other plant or animal bioplastic products), or any other polymer or plastic compound. In certain aspects, at least part of the thermally conductive portion of the microwell plate 120 may be coated with other materials such as pigments, fluorescent markers or labels, reagents, magnetic compounds, radioactive particles or molecules, biological molecules, or chemical moieties.

The wells 128 or other portions of the thermally conductive portion of the microwell plate 120 may be coated with at least one chemical, biological reagent, and/or factor. The coating 129 may be applied by any suitable method, including printing, spraying, radiant energy, ionizing, dipping, stamping, pressing, adhering, derivatizing a polymer, etching, chemically reacting, and/or any combination thereof.

By way of example, at least part of the thermally conductive portion of the microwell plate 120 may be coated with an inert material such as Teflon® (polytetrafluoroethylene), a plastic, and/or a metal plating that is compatible with the reaction to be performed in the thermal-cycling device 100. In one embodiment, the thermally conductive portion of the microwell plate comprises copper or other metal and is coated with a Teflon® coating so that the copper or other metal does not interfere with the PCR process, or any other biological or chemical reaction performed with the plate.

By way of another example, a derivatized polymer coating may be reacted with a selected chemical moiety such that covalent or non-covalent bonds occur. Chemical moieties may vary depending on the application, but may include binding partners, solid synthesis components for amino acid or nucleic acid synthesis, and/or cell culture components.

Additionally or alternatively, the wells 128 may be coated with an epitope tag, such as glutathione, or coated with an extracellular matrix component, such as fibronectin, collagen, laminin, or other similar substance. In yet another embodiment, the wells 128 can be coated with at least one poly-L or poly-D amino acid, biotinylated molecules, such as streptavidin, a resin, a polymer, a silica gel, a matrix, or other chemical. The resin, polymer, silica gel, matrix, or other chemical may operate as a separation gradient for the substance(s) in the wells 128 or as a carrier of another biological or chemical agent, such as a bifunctional heterocycle, heterocyclic building block, amine, alcohol, carboxylic acid, sulfonyl chloride, or other agent. In another embodiment, the wells 128 can be coated with at least one radioisotope, including, but not limited to, ³²P, ³⁵S, and/or ³H nucleic acid (such as thymidine, guanine, adenine, uracil, or cytosine).

Sealing Film on the Microwell Plate

Referring back to FIG. 5, at least one well 128 of the microwell plate 120 may be covered with a sealing film 126. The sealing film 126 can be an impermeable, semi-permeable, or permeable membrane, film, and/or gasket and/or any combination thereof. Further, the film 126 may be an adhesive film, a porous or a non-porous film, a chemical layer (e.g., wax or oil), and/or another type of covering and/or material that can adequately withstand temperatures of a thermal-cycling operation. The film 126 may be resealable on a surface, such as an upper surface 130, of the thermally conductive portion of the microwell plate 120. Additionally or alternatively, the film 126 may be transparent or opaque, to include being light and/or radiation transmissive or blocking, respectively. In one embodiment, the film 126 is relatively thin with a low thermal conductivity. In another embodiment, the film 126 is relatively thick with a higher thermal conductivity. If an adhesive film is utilized, for example, the adhesive film 126 may be a single-layer, multi-layer, or rolled adhesive film applied to all or a portion of the upper surface 130 of the thermally conductive portion of the microwell plate 120. In at least one embodiment, it may be desirable to reduce the space (volume) of the well that is not occupied by the reaction sample, in order to prevent or reduce condensation and/or evaporation as the substance(s) pass through high and/or low temperature cycles.

The Carrier to Support the Microwell Plate

FIG. 9 illustrates a carrier portion 106 configured to support the thermally conductive portion of the microwell plate 120 when the plate 120 or 203 is placed into the thermal-cycling device 100 (FIG. 4). In one embodiment, the thermally conductive portion of the microwell plate 120 can be permanently affixed to a carrier 106. The carrier 106 includes a frame 131 having a top portion 132, a bottom portion 134, and a plurality of depressions 136 that may correspond to a configuration of the thermally conductive portion of the microwell plate 120. The carrier 106 may be made from a variety of materials, including, but not be limited to, plastics (e.g., polypropylene, polystyrene, polyvinyl chloride, polycarbonate, etc.), glasses, metals, woods, ceramics, clay materials, polymers, molded fabrics, fiberglass, and/or any combination thereof.

In one embodiment, the carrier 106 is approximately 127mm (length) x 85mm (width) x 14mm (height), which can correspond to dimensions of a reservoir plate used in an automated process (i.e., robotically or mechanically handled and/or transferred). It is appreciated that the number of depressions 136 formed in the carrier 106 may not necessarily correlate to the number of wells 128 of the thermally conductive portion of the microwell plate 120.

The carrier 106 may be configured to meet certain industry specifications, such as those specifications provided by the Microplate Standards Development Committee of the Society of Biomolecular Screening and the American National Standards Institute for automated laboratory instrumentation. See ANSI/SBS 1-2004 (footprint dimensions), ANSI/SBS 2-2004 (height dimensions), ANSI/SBS 3-2004 (bottom outside flange dimensions), and ANSI/SBS 4-2004 (well positions). See also Astle, J. Biol. Screen. Vol. 1, No. 4, pp. 163-169 (1996), hereby incorporated by reference in its entirety. Configuring the carrier 106 to comply with certain industry specifications may allow the carrier 106 to be used with common and/or standardized automation equipment.

As further shown in FIG. 9, the thermally conductive portion of the microwell plate 120 includes a perimeter region 205 that can rest on the top portion 132 of the carrier 106. Additionally, or alternatively, a plurality of walls 140 formed between the wells 128 of the thermally conductive portion of the microwell plate 120 may be supported on a corresponding surface 142 of the carrier 106.

Method(s) of Use

The thermal-cycling device 100, carrier 106, and the thermally conductive portion of the microwell plate 120 may be used for a variety of biological and/or chemical processes. The substance or substances received in the thermally conductive portion of the microwell plate 120 may include a solid, liquid (organic or otherwise), gel, paste, emulsion, viscous liquid, vapor, or other substance. Some processes that may be conducted in the thermal-cycling device 100 include, for example, a PCR process; RNAse protection assays; reverse transcription reactions (RT); in situ hybridizations; primer extensions; Rapid Amplification of cDNA ends (RACE); synthesis of gene or protein libraries; Western blots; Northern blots; Southern blots; yeast-two hybrid screenings; nucleic acid or polypeptide-sequencing reactions; forming protein conjugates such as antibody-antigen conjugates; labeling nucleic acid(s) and/or polypeptide(s) with a fluorescent, radioactive, bioactive, functional or other tag; de novo synthesis of nucleic acid and/or peptide and/or polypeptide and/or protein probes, primers, fragments full-length molecules or variants; oligomer restriction; allele-specific oligonucleotide probe analysis (ASO); other cloning and/or ligation procedures such as site-directed mutagenesis; chemical mutagenesis; DNA shuffling; genetic recombination; blunt end cloning (including Klenow fill-in reactions) or sticky-end cloning; agrochemical screening; environmental testing, detecting, and/or monitoring gene or protein expression in a sample; pharmaceutical screening; food and/or cosmetic testing; clinical specimen testing, including diagnostics; forensic specimen testing, including diagnostics; and/or other biological and/or chemical processes.

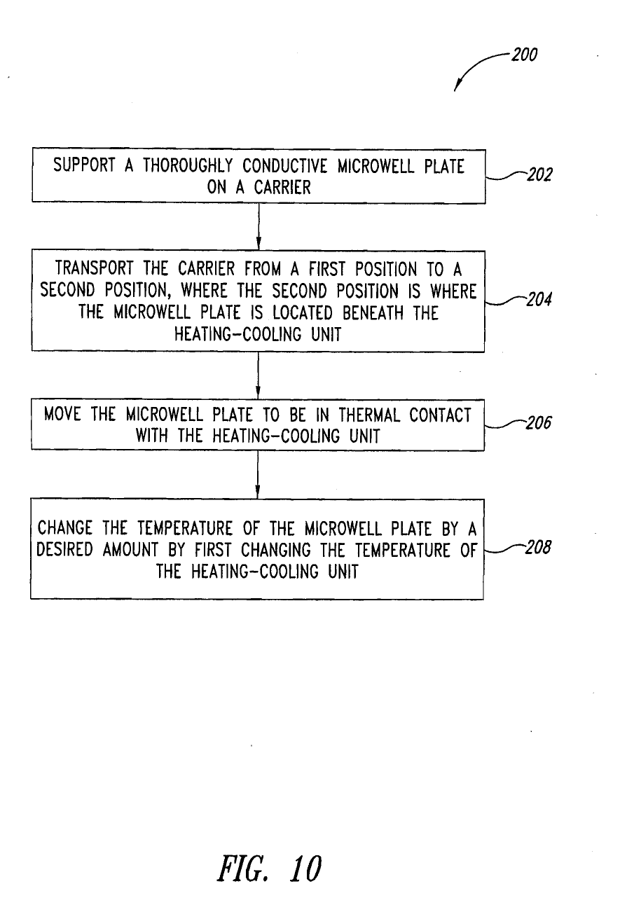

FIG. 10 is a flow diagram illustrating one embodiment of a method 200 for thermally processing at least one substance in at least one embodiment of the thermal-cycling device, such as the device 100 illustrated in FIG. 4. The method 200 may commence by supporting the thermally-conductive portion of the microwell plate 120 on the carrier 106, at step 202. The carrier 106, in turn, may be fixed to or removably supported on the transport system 108. The thermally conductive portion of the microwell plate 120 carries at least one substance in at least one well 128 formed in the plate 120. Next, the microwell plate 120 or 203 is transported via the transport system 108 from a first position to a second position, at step 204. The first position can be the position where the microwell plate 120 or 203 is initially placed on the transport system 108 or, if the carrier 106 is fixed to the transport system, the first position can be where the carrier 106 is positioned to receive the thermally conductive portion of the microwell plate 120. The second position is where the carrier 106, while supporting the thermally conductive portion of the microwell plate 120, is positioned beneath the heating-cooling unit 104. Next, the microwell plate 120 or 203 is moved to be in thermal communication with the heating-cooling unit 104, at step 206. In one embodiment, at least a portion of the heating-cooling unit 104 is moved to be in thermal contact with the microwell plate 120 or 203. Alternatively, the entire heating-cooling unit 104, may be moved to be in thermal contact with the microwell plate 120 or 203.

One of ordinary skill in the art will appreciate that the thermal contact may be direct contact between the heating-cooling unit 104 and the microwell plate 120 or 203 or may be indirect contact, where the sealing film 126 is positioned between the heating-cooling unit 104 and the microwell plate 120 or 203.

Lastly, the thermal-cycling process may commence by varying a temperature of the thermally conductive portion of the microwell plate 120 by a desired amount, which may include increasing or decreasing a present temperature of the thermally conductive portion of the microwell plate 120, at step 208. The temperature change of the thermally conductive portion of the microwell plate 120 is effected by first changing the temperature of the heating-cooling unit 104, which is in thermal contact with the thermally conductive portion of the microwell plate 120. The substance(s) carried in the wells 128 of the thermally conductive portion of the microwell plate 120 can be thermally cycled via subsequent temperature changes and/or maintenance of the temperature of the thermally conductive portion of the microwell plate 120 at a desired level.

The method 200 may rapidly heat or cool the thermally conductive microwell plate 120, which has a high thermal conductivity and a low thermal mass. In addition, there are minimal insulation barriers, if any, to overcome (i.e., the sealing film 126) between the heating-cooling unit 104 and the thermally conductive portion of the microwell plate 120. Accordingly, the thermal transfer rate into and out of the substances may be quite fast. In one embodiment, the thermal transfer rate may be in a range of about 10° Celsius/second, about 15° Celsius/second, about 20° Celsius/second, about 25° Celsius/second, about 30° Celsius/second, about 35° Celsius/second, about 40° Celsius/second, or any value therebetween or greater. Since, the thermally conductive portion of the microwell plate 120 can be in close thermal contact with the heating-cooling unit 104, the thermal-cycling device 100 may use substantially less energy than a conventional thermal-cycling device that must heat or cool a thermal block having a large thermal mass and overcome additional insulation barriers located between the substances to be heated and the heating-cooling unit.

Furthermore, absent additional insulation barriers, the thermal-cycling device 100 does not subject the carrier 106 to extreme temperatures, permitting the carrier 106 to be made from either polystyrene or polypropylene, which in turn decreases the manufacturing costs, complexity, and time as compared to conventional devices having thermal blocks.

Since the thermally conductive portion of the microwell plate 120 can transfer minimal heat to the carrier 106, the carrier 106 may be made from plastic. Accordingly, the heating or cooling of the thermally conductive portion of the microwell plate 120 will have essentially no effect on the shape of the carrier 106. The carrier 106, therefore, may be easily manipulated by automated equipment as soon as the thermal-cycling process is complete.

In addition, the thermal-cycling device 100 may produce an efficient thermal transfer between one or more Peltier units 124 and the thermally conductive portion of the microwell plate 120. In one embodiment, six Peltier units 124 can be in thermal contact with the thermally conductive portion of the microwell plate 120. The additional Peltier units 124 increase the thermal contact surface area between the heating-cooling unit 104 and the thermally conductive portion of the microwell plate 120 where the heating or cooling transfer occurs. Further, such a configuration may provide for rapid and uniform heating or cooling of the substance(s) carried in the wells 128 of the thermally conductive portion of the microwell plate 120.

In one embodiment, the thermal-cycling device 100 is used for the purpose of carrying out a PCR process. In one particular aspect, the reaction mixture comprises oligonucleotide primers complementary to the ends of the polynucleotide sequences to be amplified. These oligo primers are annealed to single-stranded (denatured) nucleic acid(s) in a test sample and a nucleic acid polymerase (such as Taq) extends the ends of the annealed primers to create a nucleic acid strand that is complementary in sequence to the nucleic acid on which the primers were annealed. The resulting double-stranded nucleic-acid product is denatured (usually at a higher temperature) to yield two single-stranded nucleic acids and the entire process is repeated or cycled several times. This entire process of primer annealing, primer extension, and denaturation generates a large number of identical or nearly identical sequences, thereby amplifying the intended target.

Typically, the primer annealing and extension temperature range includes from about 35° to about 80° C., and includes 35° C., 40° C., 45° C, 50° C., 55° C., 60° C., 65° C., 70° C., 75° C., 80° C., and any value therebetween. The denaturation temperature range typically requires temperatures from about 80° C. to about 100° C.

A typical PCR temperature cycle requires that the reaction mixture be maintained at each incubation temperature for a prescribed time period and the identical or a different cycle repeated several times. For example, one particular PCR profile may include a temperature of about 94° C. for 30 seconds (which allows for denaturation of the double stranded nucleic acid(s)). The temperature is then lowered to a temperature that is appropriate based on the primer and target sequences (usually about 37° C. to 65° C.) and this temperature is held for 30-60 seconds (again, depending on the primer sequence and other factors). Finally, the temperature is raised slightly to allow for extension of the amplified product (usually to about 50° C. to 75° C.). The cycle is generally repeated about 20 to 35 times. However, given the exceptional thermal transfer associated with certain aspects of the presently claimed invention, these standard parameters may likely be significantly abbreviated.

The PCR process may be qualitative and/or quantitative, depending on the desired goal. Detection of the PCR-amplified nucleic acid(s) may occur by using visible or ultraviolet absorbance or fluorescence, chemiluminescence, photographic and/or autoradiographic images, including direct and/or indirect detection of molecular “tags” of radioactivity, chromophores, fluorophores, chemiluminescent reagents, enzyme products, antibodies, binding moiety capable of reaction with another molecule or particle, or other analytical signal.

The various embodiments described above can be combined to provide further embodiments. All of the above U.S. patents, patent applications, and publications referred to in this specification are incorporated herein by reference. Aspects can be modified, if necessary, to employ devices, features, and concepts of the various patents, applications, and publications to provide yet further embodiments.

These and other changes can be made in light of the above-detailed description. In general, in the following claims, the terms used should not be construed to limit the invention to the specific embodiments disclosed in the specification and the claims, but should be construed to include all types of thermal-cycling devices and/or systems, microtiter, micro, and/or multi-welled plates and methods of manufacturing and/or using the same that operate in accordance with the claims. Accordingly, the invention is not limited by the disclosure, but instead its scope is to be determined entirely by the following claims and equivalents thereof.

1. A thermal-cycling device for thermally processing at least one substance, the device comprising:
a thermally conductive apparatus adapted to retain the at least one substance;
a substance processing chamber having a substance-receiving region sized to removably receive the thermally conductive apparatus; and
a heating-cooling unit operable to translate with respect to the thermally conductive apparatus to be in thermal communication therewith when the thermally conductive apparatus is positioned in the device.

2. The thermal-cycling device of claim 1 wherein the heating-cooling unit comprises a plurality of Peltier thermoelectric modules and a heat sink.

3. The thermal-cycling device of claim 1 wherein the thermally conductive apparatus comprises a metallic microwell plate.

4. The thermal-cycling device of claim 3 wherein the metallic microwell plate further comprises copper and at least part of the plate comprises a non-reactive coating.

5. The thermal-cycling device of claim 1 wherein a surface of the thermally conductive apparatus comprises a sealing film.

6. The thermal-cycling device of claim 1 wherein the heating-cooling unit includes at least one heat spreader positioned proximate the thermally conductive apparatus.

7. An apparatus in the form of a plate for supporting at least one substance to be chemically or biologically processed, the apparatus comprising:
a thermally conductive material having an upper surface; and
at least one depression or well formed in the thermally-conductive material, the at least one depression or well configured to retain a desired volume of at least one substance,
wherein a thermal conductivity of the thermally-conductive material permits a temperature change of the material to rapidly affect a temperature of the substance.

8. The apparatus of claim 7 comprising between approximately 1 and 20,000 depressions or wells.

9. The apparatus of claim 7, wherein said thermally conductive material comprises copper.

10. The apparatus of claim 7, wherein at least one depression or well is at least partially coated with a non-reactive coating.

11. The apparatus of claim 7, further comprising:
a sealing film placed on the upper surface of the thermally conductive plate to seal the at least one substance in the plurality of wells.

12. The apparatus of claim 7 wherein the thermally conductive plate comprises a thermal conductivity of at least 5.0 calories/meter*Kelvin.

13.-17. (canceled)

18. A thermal-cycling device for thermally processing at least one substance, the device comprising:
a housing;
a heating-cooling unit moveably coupled to the housing; and
a plate having a plurality of wells, an upper surface and a lower surface, the wells being adapted to retain desired volumes of the at least one substance and at least a portion of the plate being operable to translate with respect to the heating-cooling unit to be in thermal communication therewith.

19. The thermal-cycling device of claim 18, further comprising:
a film located between at least a portion of the plate and the heating-cooling unit.

20. The thermal-cycling device of claim 19 wherein the portion of the plate is in direct contact with the film.

21. The thermal-cycling device of claim 19 wherein the film is a sealing film adapted to seal at least some of the plurality of wells.

22. The thermal-cycling device of claim 19 wherein the portion of the plate is in direct contact with the heating-cooling unit.

23. The thermal-cycling device of claim 18 wherein the heating-cooling unit comprises a Peltier thermoelectric module and a heat sink.

24-41. (canceled)

42. A method for thermally processing at least one substance in a thermal-cycling device, the method comprising:
supporting a thermally-conductive microwell plate on a carrier, the plate carrying the at least one substance in at least one well formed in the plate;
moving the carrier and the microwell plate from a first position to a thermal processing position in the device, proximate a heating-cooling unit;
arranging at least a portion of a surface of the plate to be in thermal contact with at least a portion of the heating-cooling unit; and
changing a temperature of the plate by a desired amount by changing a temperature of the heating-cooling unit.

43. The method of claim 42 wherein moving the carrier and the plate includes moving the carrier and the plate on a conveyor transport system.

44. The method of claim 42 wherein arranging at least the portion of the surface of the plate to be in thermal contact with at least the portion of the heating-cooling unit includes placing a sealing film on the surface of the plate in direct contact with at least the portion of the heating-cooling unit.

45. The method of claim 42 wherein arranging at least a portion of the surface of the plate to be in thermal contact with at least the portion of the heating-cooling unit includes placing at least the portion of the surface of the plate in direct contact with at least the portion of the heating-cooling unit.
